(19) United States
(12) Patent Application Publication
(10) Pub. No.: US 2025/0115321 A1
(43) Pub. Date: Apr. 10, 2025

(54) DEVICE AND METHOD FOR CHANGING THE CENTER OF GRAVITY OF A BICYCLE ACCORDING TO THE SITUATION

(71) Applicant: Stabilus GmbH, Koblenz (DE)

(72) Inventors: Daniel BODARNEA, Brasov (RO); Michael HEWEL, Boppard Udenhausen (DE); Lars LÖHKEN, Linz am Rhein (DE); Markus MÜLLER, Koblenz (DE); Peter OSTER, Koblenz (DE); Raphael PIROTH, Miehlen (DE); Ulrich PROBST, Hillscheid (DE); Andreas SEUS-KAPELLEN, Boppard Udenhausen (DE)

(21) Appl. No.: 18/907,200

(22) Filed: Oct. 4, 2024

(30) Foreign Application Priority Data
Oct. 10, 2023 (DE) 102023127652.2
Jun. 6, 2024 (DE) 102024115756.9

(51) Int. Cl. B62J 1/06; B62J 45/41

(52) U.S. Cl. CPC B62J 1/065; B62J 45/41

(57) ABSTRACT

A device, system, or method for changing the center of gravity of a bicycle, in particular an electric bicycle, to suit the situation, with:
an actuator for changing the center of gravity of the bicycle,
at least one sensor that monitors the riding status of the bicycle,
a control unit which receives and processes data from the sensor, determines a center of gravity of the bicycle adapted to the situation and outputs corresponding control signals to the actuator in order to carry out the change in center of gravity. According to the invention, an adjustment speed of the change in the center of gravity can be adapted to a riding state of the bicycle.

### RELATED APPLICATION

This U.S. patent application claims priority to German Patent Application No. 102023127652.2, filed on Oct. 10, 2023 and German Patent Application No. 102024115756.9, filed on Jun. 6, 2024, which are both hereby incorporated by reference in their entirety.

### DESCRIPTION

The invention relates to a device for situation-adapted changing of the center of gravity of a bicycle, in particular an electric bicycle, with an actuator for changing the center of gravity, at least one sensor monitoring the riding condition of the bicycle, and a control unit which receives and processes data from the sensor, determines a situation-adapted center of gravity of the bicycle and outputs corresponding control signals to the actuator in order to carry out the change in center of gravity.

Increasing demands in road traffic are leading to a growing need for safety measures, particularly for cyclists. Due to the bike's high center of gravity, which is further exacerbated by a rider, critical riding situations are the result, for example when braking. With electric bicycles, the problem is exacerbated by the significantly higher speed. At the same time, comfort requirements are increasing, as electric bikes in particular are reaching other or additional target groups of riders.

Devices and methods for changing the center of gravity of an electric bicycle to suit the situation are therefore known from the state of the art. However, there is a need to further improve the known devices and methods.

It is therefore the object of the invention to provide a device, a system, a bicycle and a method for changing the center of gravity of a bicycle depending on the situation, which further increases the safety of the cyclist.

The present invention provides a device according to claim 1 which achieves the technical object. The object is further achieved by a system according to claim 16, a bicycle according to claim 17 and a method according to claim 18. Advantageous designs are the subject matter of the dependent claims.

Specifically, the task is achieved by a device for situation-adapted change of the center of gravity of a bicycle, in particular an electric bicycle, with an actuator for changing the center of gravity, at least one sensor monitoring the riding condition of the bicycle, and a control unit which receives and processes data from the sensor, determines a situation-adapted center of gravity of the bicycle and outputs corresponding control signals to the actuator in order to carry out the change of center of gravity.

According to the invention, an adjustment speed of the change in the center of gravity can be adapted to a riding state of the bicycle. In critical riding situations in particular, it is advantageous if the bike's center of gravity changes as quickly as possible to increase the cyclist's safety. For example, it is advantageous to lower the center of gravity quickly if, for example, an ABS sensor detects safety-critical braking or a critical inclination of the bike.

At this point, it should be noted that in the context of the invention, a riding situation is to be understood not only as a riding operation, but also as a stationary operation of the bicycle. The general term bicycle also includes single-track muscle-powered bicycles, electric bicycles or pedelecs, as well as multi-track cargo or transport bicycles or cargo bikes (muscle-powered or with electric drive).

Preferably, the actuator is used to change the center of gravity by adjusting the height of a seat post of the bicycle. Lowering the seat post also allows the rider to stand with both feet firmly on the ground. In non-critical riding mode, on the other hand, a more ergonomic seat position can be achieved. It is possible to approach these positions automatically according to a suitable presetting.

According to an advantageous embodiment of the invention, the actuator may have at least one drive unit and a transmission unit driven by the drive unit. The drive unit can, for example, be operated simply by means of an accumulator.

Different adjustment speeds of the seat post can be realized in a simple manner wherein the transmission unit has a shiftable transmission with at least two different ratios, wherein the ratios of the transmission unit can be selected depending on the riding condition of the bicycle, such that the adjustment speed of the seat post in the lowering and lifting direction is adapted to the riding condition of the bicycle.

An advantageous design can be achieved if the transmission unit has a freewheel that is dependent on the direction of rotation in order to adapt the transmission ratio to the riding condition of the bicycle. The freewheel can be used, for example, to lock a gear stage in one direction of rotation and release it in the opposite direction, so that a full transmission ratio of the gear unit is available in the lifting direction and only a lower partial transmission ratio is available in the lowering direction. The adjustment speed in the lowering direction can thus be greatly increased.

For example, an electric motor could be used as the drive unit and a single-stage or multi-stage planetary gear as the transmission.

An alternative advantageous embodiment of the invention provides for the adjustment speed of the seat post to be adapted to the riding condition of the bicycle by means of a suitable design of the transmission unit and/or the motor characteristic curve in the lowering and lifting direction.

Furthermore, a force compensation element can advantageously be provided, which supports an extension movement of the seat post in the lifting direction. A spring bellows that can be pressurized can be provided as a force compensation element, which supports an extension movement of the seat post in the lifting direction. If the seat post has additional spring means, the bellows can advantageously also be designed as a pressure accumulator for the spring means. Alternatively, it is conceivable to provide a gas spring element as a force compensation element.

In an advantageous further development of the invention, the actuator can be designed as an electric spindle drive and comprise a drive arrangement arranged in a housing with the drive unit and the gear unit driven by the drive unit, a spindle which can be rotationally driven by the drive unit about an axis of rotation, which is in threaded engagement with a spindle nut in such a manner that the spindle nut is non-rotatably displaceable in an axial direction within the housing, and a seat tube as an adjusting element for adjusting the height of the seat post, which can be displaced along a displacement axis relative to the drive arrangement by means of the drive unit.

Here, the spindle nut can be positively connected to the adjusting element in such a manner that the connection can absorb forces in the direction of pressure. The positive fit can be achieved simply by means of a clip connection, wherein the spindle nut can be manufactured cost-effectively.

To increase riding comfort, according to an advantageous embodiment of the invention, it is provided that the seat post has a seat suspension. Examples include parallelogram suspension seat posts, which can be adapted using replacement spring elements, for example.

Preferably, a gas power support can be provided for adjusting the seat suspension, wherein an axially adjustable adjustment element for gas power support has a pressure chamber which can be variably filled with gas by means of a valve. The mechanical seat suspension can be adjusted as required using the gas force in the pressure chamber. The valve makes it easy to adjust the suspension at any time without removing the seat post. At the same time, the mechanics can be better and permanently protected from external influences such as weather, rain, dirt, etc., as no replacement is necessary to change the suspension and the suspension no longer needs to be easy to dismantle. The individual adjustment of the suspension can only be made via the valve.

The pressure chamber can be limited on a side facing the seat suspension by a plunger arranged in the seat tube so as to be axially displaceable as a function of a gas volume in the pressure chamber, wherein a tappet arranged on the plunger is in operative connection with the mechanical seat suspension in such a way that an axial displacement of the plunger causes a change in the seat suspension. If the mechanical seat suspension is designed as a parallelogram spring unit with articulated side and support components and a spring element, the spring force can be adjusted as required by adjusting the joints. The spring element could be a mechanical helical compression spring or a deformable elastomer element, for example. As already mentioned, it is no longer necessary to replace the spring element to adjust the suspension and the spring element and joints can be better and permanently protected from external influences.

According to a further advantageous embodiment of the invention the sensor can be designed as a proximity switch, which is designed to scan a contour of a brake disk of the bicycle.

The brake disk can have cams for positive fit connection with a carrier and the cams can be scanned by means of the proximity switch. This enables a very fine signal resolution without additional sensor elements. At the same time, the proximity switch and brake disk offer a robust and cost-effective system to implement.

The object is further achieved by a system for situation-adapted changing of the center of gravity of a bicycle, in particular an electric bicycle with one of the above-mentioned devices according to the invention as well as with an electrically activatable main stand and/or a semi- or fully automated handbrake.

Furthermore, the object is achieved by a bicycle with the above-mentioned device according to the invention or with the above-mentioned system according to the invention.

Further aspects of the invention relate to a method for changing the center of gravity of a bicycle, in particular an electric bicycle, to suit the situation, comprising the steps of:
capturing of sensor data depicting the riding status of the bike,
evaluating the sensor data and determining a situation-adapted center of gravity for the bike,
generating a control signal to change the bike's center of gravity,
outputting of the control signal to an actuator to carry out the change in center of gravity,
adjusting the adjustment speed of the change in the center of gravity to a riding condition of the bicycle.

Preferably, the center of gravity is changed by adjusting the height of a seat post of the bicycle using the actuator. The height adjustment of the seat post is advantageously faster in the lowering direction than in the lifting direction, which can defuse critical riding situations.

In a preferred embodiment, the center of gravity can be changed by means of a device as described above.

The present invention will be described below with reference to several embodiments. Identical or similar components are marked with the same reference symbol. The drawings, the description, and the claims contain numerous features in combination. A person skilled in the art will expediently also consider the features individually and combine them to form expedient further combinations. Individual or several embodiments can therefore be advantageously combined with one another.

In the drawings:

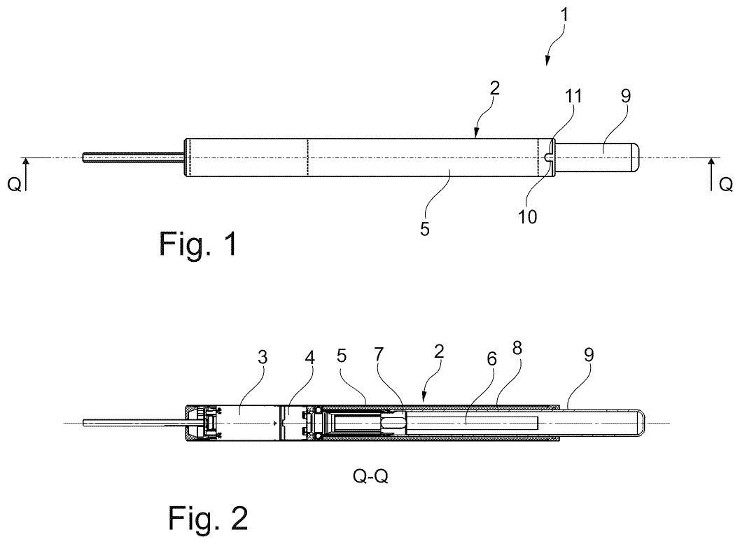

FIG. 1 shows a schematic representation of an actuator for a device according to the invention for changing the center of gravity of a bicycle to suit the situation;

FIG. 2 shows a cross-section of the actuator shown in FIG. 1;

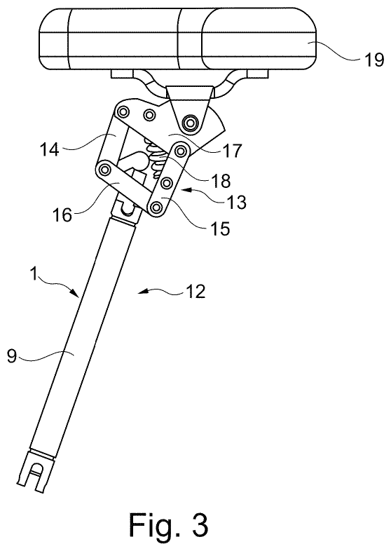

FIG. 3 shows a side view of an embodiment of a device according to the invention without a transmission unit of the actuator with spring-loaded seat suspension;

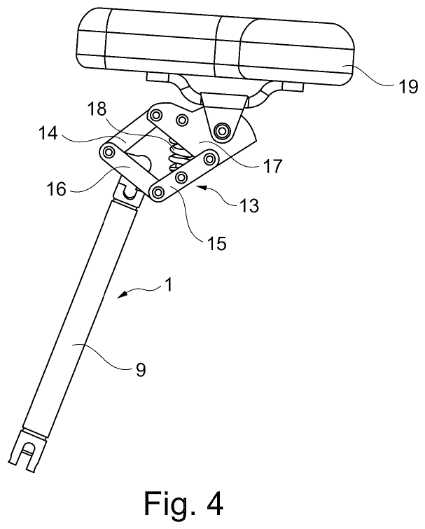

FIG. 4 shows a side view of the device according to FIG. 3 without a gear unit of the actuator with sprung-in seat suspension;

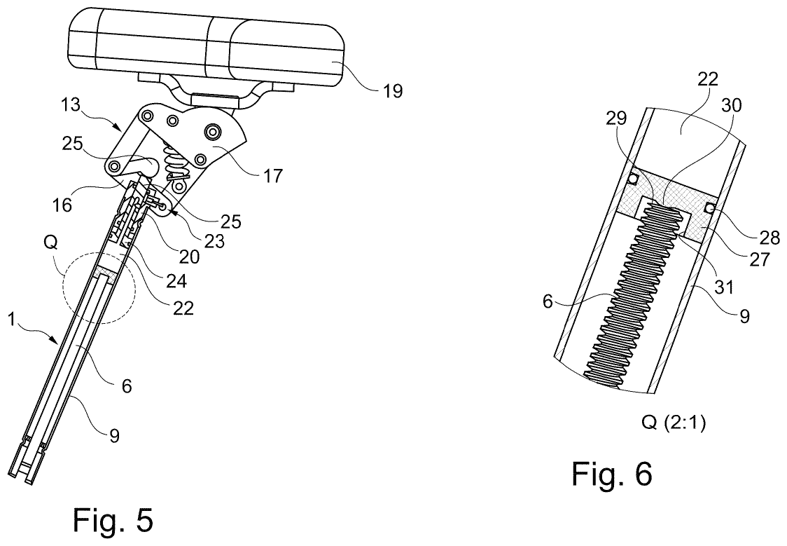

FIG. 5 shows a cross-section of the device shown in FIG. 4;

FIG. 6 shows an enlarged section Q of the cross-section shown in FIG. 5;

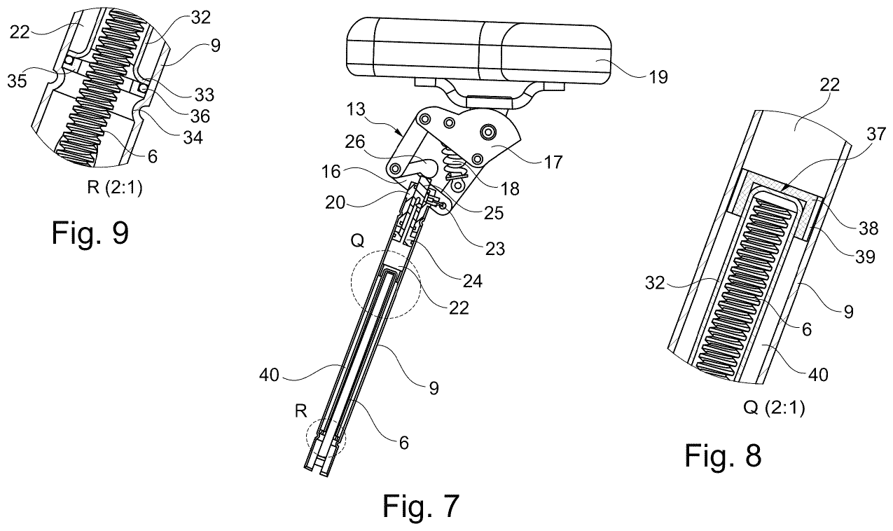

FIG. 7 shows a cross-section of another embodiment of a device according to the invention;

FIG. 8 shows an enlarged section Q of the cross-section shown in FIG. 7 and

FIG. 9 shows an enlarged section R of the cross-section shown in FIG. 7.

FIG. 1 shows an actuator 2 of a device 1 for changing the center of gravity of a bicycle to suit the situation. In the context of the invention, a bicycle can be a single-track muscle-powered bicycle, an electric bicycle or a pedelec or a multi-track load, transport or cargo bicycle (muscle-powered or with electric drive).

In order to increase the safety of a bicycle, the device 1 according to the invention for changing the center of gravity of a bicycle to suit the situation comprises the actuator 2 for changing the center of gravity, at least one sensor monitoring the riding condition of the bicycle, and a control unit which receives and processes data from the sensor, determines a center of gravity of the bicycle to suit the situation and outputs corresponding control signals to the actuator in order to carry out the change in center of gravity.

For example, a speed signal could be generated by scanning the contour of a brake disk. One or more proximity switches can be used for this purpose, by means of which spiral arms of the brake disk are scanned. Alternatively, a brake disk made of steel, which is arranged coaxially on a carrier made of aluminum, for example, can have inwardly directed, preferably eighteen cams for positive connection with the carrier. These can be scanned with a suitable sensor, e.g. a proximity switch, to generate a signal for the speed of the bicycle. Additional sensor elements may not be required as a result. An adjustment speed of the center of gravity change is adapted to a riding condition of the bicycle so that the center of gravity of the bicycle can be changed as quickly as possible, especially in critical riding situations. For example, it is advantageous to lower the center of gravity quickly if, for example, safety-critical braking is detected by an ABS sensor or a safety-critical inclination of the bicycle is detected by suitable sensors.

In the embodiment example described, the center of gravity is changed by adjusting the height of a seat post 12 of the bicycle, but is not limited to this. The height can be adjusted automatically depending on the bike's riding position. It is also conceivable that a height adjustment is additionally controlled by the cyclist.

Lowering the seat post 12 also allows the rider to stand with both feet firmly on the ground. In non-critical riding mode, on the other hand, a more ergonomic seat position can be achieved. It is possible to approach these positions automatically according to a suitable presetting.

The actuator 2 has at least one drive unit 3 and a transmission unit 4 driven by the drive unit 3, wherein, for example, an electric motor is used as the drive unit and a single-stage or multi-stage planetary gear is used as the transmission. On a bicycle with an electric drive, the drive unit 3 can be operated using the battery of the electric drive.

According to the design example shown, the actuator 2 can be designed as an electric spindle drive. As can be seen in particular from FIG. 2, which shows a cross-section, the actuator 2 comprises a drive arrangement arranged in a housing 5 with the drive unit 3 and the gear unit 4 driven by the drive unit 3, a spindle 6 which can be rotationally driven by the drive unit 3 about an axis of rotation and which is in threaded engagement with a spindle nut 7. The spindle nut 7 is provided so that it can be moved in an axial direction within the housing 5 or a profiled tube 8 arranged in the housing 5. Furthermore, the actuator 2 has a seat tube 9 designed as an adjustment element for adjusting the height of the seat post 12, which can be displaced relative to the drive arrangement along a displacement axis by means of the drive unit 3.

The profile tube 8 can preferably be made of plastic and allows internal torque support for the axially displaceable spindle nut 7, which is connected to the seat tube 9 in such a way that the connection can absorb forces in the direction of pressure. A simple clip connection is conceivable. For this purpose, the spindle nut 7 can have elastic spring arms that can be clipped into recesses in the profile tube 8. The spindle nut 7 can also be connected directly to the seat tube 9 via a corresponding connection.

On its outside, the profiled tube 8 has one or more nose-shaped protrusions 10, which engage in complementary recesses 11 of the housing 5 to prevent rotation or to transmit torque. In addition, a further torque-transmitting connection can be made by partially deforming the housing 5, wherein the material of the housing 5 is pressed into the material of the profile tube 8. The connection also allows a seal between the profile tube 8 and housing 5.

In the present embodiment, the housing 5 forms the fixed part of the seat post that can be attached to the frame of a bicycle. The adjusting element 9, on the other hand, forms the height-adjustable part of the seat post 12, to which a seat 19 of the bicycle can be attached. When a situation is detected in which a change in the bicycle's center of gravity is advantageous, the drive unit 3 is activated by the control unit and the seat post 9 is moved accordingly in the axial direction along the displacement axis, so that the change in center of gravity can be achieved by adjusting the height of the bicycle's seat post. The height adjustment of the seat post is faster in the lowering direction than in the lifting direction, which can significantly defuse critical riding situations.

The different adjustment speeds of the seat post 12 can, for example, be adapted to the riding condition of the bicycle by a suitable design of the gear unit and/or the motor characteristic curve in the lowering and lifting direction.

An alternative embodiment provides for the transmission unit to be designed as a shiftable transmission with at least two different ratios, wherein the ratios of the transmission unit can be selected depending on the riding condition of the bicycle, such that the adjustment speed of the seat post 12 in the lowering and lifting direction is adapted to the riding condition of the bicycle. To adapt the transmission ratio to the riding condition of the bicycle, the transmission unit can have a freewheel that is dependent on the direction of rotation, for example. By means of the freewheel, a gear stage can be locked in one direction of rotation and released in the opposite direction, so that a full transmission ratio of the gear unit is available in the lifting direction and only a lower partial transmission ratio is available in the lowering direction. The adjustment speed in the lowering direction can thus be greatly increased.

It is also conceivable to design the device with a force compensation element that supports an extension movement of the seat post 12 in the lifting direction. A spring bellows that can be pressurized can be provided as a force compensation element, which supports an extension movement of the seat post in the lifting direction. If the seat post 12 has additional spring means, the bellows can advantageously also be designed as a pressure accumulator for the spring means. It is also conceivable to provide a gas spring element as a force compensation element.

The device described can be combined as part of a system for changing the center of gravity of a bicycle to suit the situation with an electrically activated kickstand and/or a semi-or fully automated handbrake.

The device 1 may further comprise a mechanical seat suspension 13 shown in FIG. 3, wherein the seat tube 9 is connected to the seat suspension 13. The mechanical seat suspension 13 can be designed as a parallelogram spring seat post with articulated side and support components 14, 15, 16, 17 and a spring element 18. Here, the seat tube 9 is connected to a first support component 16 and a seat 19 of the bicycle is connected to an opposite, second support component 17, wherein the side components 14, 15 are each articulated to the support components 16, 17 to form a parallelogram. The spring element 18, designed for example as a mechanical helical compression spring, is known to be arranged between two of the parallelogram components 14 to 17 to provide suspension. The seat suspension 13 is connected to the seat tube 9 by means of the first support component 16 or by means of a connecting component 20 mounted on the first support component 16.

FIG. 3 shows the seat suspension 4 in a deflected state, in which the two support components 16, 17 have the maximum distance between them. In a compressed state, which is shown in FIG. 4 for example, the spring element 19 is compressed so that the distance between the support components 16, 17 is reduced.

The mechanical seat suspension 13 can be designed with a minimum spring force, as the device 1 provides gas power support as described below. The gas power support is parallel to the seat suspension, which makes it possible to adjust the overall suspension force.

FIG. 5 shows a cross-section of the device 1 shown in FIGS. 3 and 4. As can be seen, the actuator is designed as an electric spindle drive, the spindle 6 of which is arranged in the seat tube 9.

For gas power support, a pressure chamber 22 is provided in the seat tube 9, which can be variably filled with gas or air by means of a valve 23. The mechanical seat suspension can be adjusted as required by the gas force in the pressure chamber 22. The suspension can be easily adjusted at any time via valve 23 using an air pump without removing the seat post.

On a side facing the seat suspension 13, the pressure chamber 22 is limited by a plunger 24 arranged axially displaceably in the seat tube 9. The plunger 24 is guided in a sealed manner in the seat tube 9 and has a tappet 25, which also extends in a sealed manner through a recess in the connecting component 20. As can be seen in FIG. 5, the free end of the tappet 25 protrudes from the connecting part 20 and is in operative connection with the mechanical seat suspension 13 via a cam 26, such that an axial displacement of the plunger 24 causes a change in the seat suspension by adjusting the parallelogram components 14 to 17.

On the actuator side, the pressure chamber 22 is limited by a sealing separating piston 27 that can be axially displaced in the seat tube 9 by means of the spindle 6. Sealing is achieved, for example, by an O-ring 28 positioned in a ring groove of the separating piston 27. In this embodiment, a spindle end 29 facing away from the actuator is in rotatable contact with the separating piston 27 or a protrusion 30 of the separating piston 27 in order to minimize frictional forces. As can be seen from FIG. 6, the protrusion 30 is arranged at the bottom of a recess 31 of the separating piston 27, so that additional guidance of the spindle end 29 is possible. The pressure chamber 22 is also limited here on the side facing the seat suspension 13 by the plunger 24, which is axially displaceable in the seat tube 9 and whose entire plunger surface is effective. This allows a relatively high adjustment force to be generated on the tappet 25. Due to the gas present in the pressure chamber 22, the separating piston 27 remains in contact with the spindle 6 and is displaced within the seat tube 9 as a function of the adjustment movement. The gas pressure can thus act on the entire separating piston surface, which supports an extension force of the actuator in addition to the spring force of the seat suspension 13. The size of the pressure chamber 22 is stroke-dependent in this embodiment example, so that the gas power support can be adjusted depending on the stroke.

FIGS. 7 to 9 show a further embodiment. FIG. 7 shows a cross-section P-P of another embodiment of the device 1. As can be seen, the actuator 2 is designed as an electric spindle drive, the spindle 6 of which is arranged in the seat tube 9. The spindle 6 is driven in rotation about an axis of rotation by the drive unit of the drive arrangement, which is not shown, and is in threaded engagement with the spindle nut 7, which is not shown. The spindle nut 7 itself is provided for axial displacement within the housing 5 and is non-rotatably connected to the seat post 9, which can be displaced along an adjustment axis for height adjustment of the seat post 12 by means of the actuator 2 relative to the drive arrangement. The connection between the spindle nut 7 and the seat tube 9 is designed in such a manner that it can absorb forces in the direction of pressure. An easy-to-produce clip connection is conceivable for this purpose, in which the spindle nut 7 has elastic spring arms that can be clipped into recesses in the seat tube 9.

In the present embodiment example, the housing, which is not shown, forms the fixed part of the seat post 12 that can be attached to the frame of a bicycle.

The pressure chamber 22, which can be variably filled with air by means of the valve 13, is provided in the seat tube 9 for gas power support. The mechanical seat suspension 13 can be adjusted as required by the gas force in the pressure chamber 22. The suspension can be easily adjusted at any time via the valve 23 using an air pump without removing the seat post 12.

On a side facing the seat suspension 13, the pressure chamber 22 is limited by the plunger 24 arranged axially displaceably in the seat tube 9. The plunger 24 is guided in a sealed manner in the seat tube 9 and has the tappet 25, which also extends in a sealed manner through a recess in the connecting component 20. As can be seen in FIG. 7, the free end of the tappet 25 protrudes from the connecting part 20 and is in operative connection with the mechanical seat suspension 13 via a cam 26, such that an axial displacement of the plunger 24 causes a change in the seat suspension by adjusting the parallelogram components 14 to 17.

On the actuator side, the pressure chamber in the embodiment example shown in FIGS. 7 to 9 is limited by a separating tube 32 which at least partially surrounds the spindle 6 and projects into the seat tube 5. The separating tube 32 is substantially pot-shaped and lies tightly against the seat tube 9 with a cross-sectionally widened separating tube end 33. For this purpose, the seat tube 9 has a shoulder 34 pointing radially inwards, which can be formed, for example, by shaping the seat tube material. To seal the separating tube end 33 against the seat tube 9, a washer 35 with a radially extending sealing element 36 can also be arranged between the separating tube end 33 and the shoulder 34.

This gas power support of this embodiment example is independent of the stroke, since when the actuator is actuated, i.e. when the seat tube 9 is adjusted, the separating tube 32 moves with the seat tube 9 along the adjustment axis.

From FIG. 8, which shows an enlarged section Q of FIG. 7, it can be seen that the separating tube 32 is guided with its further end 37 in a guide element 38 in the seat tube 9, wherein the guide element 38 has axially extending recesses 39 on its outer side. Through the recesses 39, the air fed into the pressure chamber 22 through the valve 23 can also enter an annular space 40, which the separating tube 32 forms with the seat tube 9. The pressure chamber 22 thus extends from the plunger 24 to the separating tube end 33, providing a large pressure volume and a flat gas force characteristic curve.

1. A device for changing the center of gravity of a bicycle to suit the situation, the device comprising:
an actuator for changing the center of gravity of the bicycle,
at least one sensor that monitors the riding status of the bicycle,
a control unit which receives and processes data from the sensor, determines a center of gravity of the bicycle adapted to the situation and outputs corresponding control signals to the actuator in order to carry out the change in center of gravity,
wherein an adjustment speed of the center of gravity change can be adapted to a riding condition of the bicycle.

2. The device according to claim 1, wherein the change in center of gravity is effected by means of the actuator by adjusting the height of a seat post of the bicycle.

3. The device according to claim 2, wherein the actuator has at least one drive unit and a transmission unit driven by the drive unit.

4. The device according to claim 3, wherein the transmission unit has a shiftable transmission with at least two different ratios, wherein the ratios of the transmission unit can be selected as a function of the riding state of the bicycle, such that the adjustment speed of the seat post in the lowering and lifting direction is adapted to the riding state of the bicycle.

5. The device according to claim 4, wherein the transmission unit has a freewheel which is dependent on the direction of rotation in order to adapt the transmission ratio to the riding state of the bicycle.

6. The device according to claim 3, wherein the adjustment speed of the seat post is provided to be adapted to the riding condition of the bicycle by means of a suitable design of the transmission unit and/or the motor characteristic in the lowering and lifting direction.

7. The device according to claim 2, wherein a force compensation element is provided, which supports an extension movement of the seat post in the lifting direction.

8. The device according to claim 7, wherein a spring bellows which can be subjected to pressure is provided as a force compensation element, which supports an extension movement of the seat post in the lifting direction.

9. The device according to claim 8, wherein the seat post has additional spring means, wherein the spring bellows is designed as a pressure accumulator for the spring means.

10. The device according to claim 7, wherein a gas spring element is provided as a force compensation element, which supports an extension movement of the seat post in the lifting direction.

11. The device according to claim 3, wherein the actuator is designed as an electric spindle drive, comprising:
a drive arrangement arranged in a housing with the drive unit and the transmission unit driven by the drive unit,
a spindle which can be rotationally driven by the drive unit about an axis of rotation and which is in threaded engagement with a spindle nut in such a way that the spindle nut can be displaced in the axial direction within the housing in a rotationally fixed manner,
a seat tube as adjusting element for adjusting the height of the seat post, which can be displaced relative to the drive arrangement along a displacement axis by means of the drive unit.

12. The device according to claim 11, wherein the spindle nut is positively connected to the adjusting element in such a manner that the connection can absorb forces in the direction of pressure.

13. The device according to claim 2, wherein the seat post has a seat suspension.

14. The device according to claim 13, wherein a gas power support is provided for adjusting the seat suspension, wherein an axially adjustable adjusting element for gas power support has a pressure chamber which can be variably filled with gas by means of a valve.

15. The device according to claim 1, wherein the sensor is designed as a proximity switch, which is designed to scan a contour of a brake disc of the bicycle.

16. A system for changing the center of gravity of a bicycle to suit the situation, the system comprising:
a device according to claim 1 and with
an electrically activated center stand and/or a semi- or fully automatic handbrake.

17. An electric bicycle having a device according to claim 1.

18. A method for changing the center of gravity of a bicycle to suit the situation, comprising the steps of:
capturing of sensor data depicting the riding status of the bike,
evaluating the sensor data and determining a situation-adapted center of gravity for the bike,
generating a control signal to change the bike's center of gravity,
outputting of the control signal to an actuator to carry out the change in center of gravity,
adjusting the adjustment speed of the change in the center of gravity to a riding condition of the bicycle.

19. The method according to claim 18, wherein the change in center of gravity is effected by adjusting the height of a seat post of the bicycle by means of the actuator.

20. The method according to claim 19, wherein the height adjustment of the seat post is faster in the lowering direction than in the lifting direction.
